(19) United States
(12) Patent Application Publication
(10) Pub. No.: US 2025/0376200 A1
(43) Pub. Date: Dec. 11, 2025

(54) BARRIER TRANSPORTERS

(71) Applicant: Delta Scientific Corporation, Palmdale, CA (US)

(72) Inventor: Matthew Ownes, Glendale, CA (US)

(21) Appl. No.: 19/228,307

(22) Filed: Jun. 4, 2025

Related U.S. Application Data
(60) Provisional application No. 63/656,593, filed on Jun. 5, 2024.

(51) Int. Cl. B62B 1/14; B62B 5/06; E01F 13/12

(52) U.S. Cl. CPC B62B 1/14; B62B 5/06; B62B 2203/00; E01F 13/12

(57) ABSTRACT

A portable barrier transporter includes a body, a first wheel coupled to the body, a second wheel coupled to the body opposite the first wheel. A first arm extends transversely from the body. A channel extends from the first arm for receiving a lower end portion of a plate member of a portable barrier. A second arm extends from the body in a direction opposite the first arm and above the first arm, and a third wheel is coupled to the second arm.

### CROSS-REFERENCE TO RELATED APPLICATION

This application is based upon and claim priority on U.S. Provisional Application No. 63/656,593, filed on Jun. 5, 2024, the contents of which are fully incorporated herein by reference.

### BACKGROUND

Barriers are commonly deployed to protect individuals and/or property against attack by a vehicle, such as a truck bomb attack. Many barriers are partly embedded into the ground or are otherwise attached to the ground. However, excavation or attachment to the roadway surface is both costly and time-consuming, which inhibits rapid deployment of the barricade. Thus, portable barriers that can easily be moved into a location to be protected are finding use. Such portable barriers need to be transported to their desired location and back to storage, if necessary.

### SUMMARY

In one example embodiment, a portable barrier transporter includes a body, a first wheel coupled to the body at, or proximate, a bottom end of the body, a second wheel coupled to the body at, or proximate, a bottom end of the body, opposite the first wheel, wherein the first and second wheels rotate about a first axis. A first arm extends transversely from the body at, or proximate the bottom end, of the body. A channel extends from the first arm parallel, or generally parallel, to first axis for receiving a lower end portion of a plate member of a portable barrier. A second arm extends from the body in a direction opposite the first arm and above the first arm, and a third wheel is coupled to the second arm, such that when the body is titled about the first axis, the first, second and third wheels all engage the ground. In another example embodiment, the transporter also includes a holding arm rotatably coupled to the body. The holding arm includes a slot for receiving an upper end portion of the plate member of the portable barrier. In yet another example embodiment, the holding arm is rotatable relative to the body from a first position where the slot is in a position for not receiving the upper end portion of the plate and a second position where the slot is positioned to receive the upper end portion of the plate. In a further example embodiment, the holding arm is lockable at the first position and at the second position. In yet a further example embodiment, the holding arm includes a slideable pin that is received in a first opening when at the first position and in a second opening when in the second position for locking the holding arm in those positions. In one example embodiment, the pin is a spring-loaded plunger. In another example embodiment, a plate is coupled to the body and the first and second openings are formed on the plate. In another example embodiment, the body includes a main portion extending axially and an upper portion extending from an upper end of the main portion at an angle relative to the main portion. In yet another example embodiment, the transporter also includes a first handle extending from the upper portion and a second handle extending from the upper portion opposite the first handle. In a further example embodiment, the transporter further includes a base portion extending transversely from a bottom end of the main portion. In yet a further example embodiment, the base portion extends perpendicularly from the main portion. In one example embodiment, the first and second wheels are mounted on the base portion. In another example embodiment, the main portion and the base portions are beams. In yet another example embodiment, the main portion and base portion are square beams. In a further example embodiment, the body is formed from ASTM A36 hot rolled steel.

### BRIEF DESCRIPTION OF THE DRAWINGS

FIG. 1 is a side view of an example embodiment portable barrier in an upright position.

FIG. 2 is a perspective view of the example embodiment portable barrier shown in FIG. 1.

FIG. 3 is a side view of the example embodiment portable barrier shown in FIG. 1 in a pivoted position after impact.

FIG. 4 is side view of a vehicle about to impact the upright example embodiment portable barrier shown in FIG. 1.

FIG. 5 is a side view of the example embodiment portable barrier shown in FIG. 4 after impact by the vehicle shown in FIG. 4.

FIG. 6 is a perspective view of another example embodiment portable barrier.

FIG. 7 is a side view of another example embodiment portable barrier shown in FIG. 6.

FIG. 8 is a partial perspective assembly view of an example embodiment shoe mounted on an inner surface of a support member the example embodiment portable barrier shown in FIG. 6.

FIG. 9 is a perspective view of an example embodiment shoe mounted on an outer surface of a support member of the example embodiment portable barrier shown in FIG. 1.

FIG. 10 is a top view of another example embodiment portable barrier.

FIG. 11 is a perspective view of stacked portable barriers.

FIG. 12 is a perspective view of an example embodiment transporter.

FIG. 13 is a perspective view of an example embodiment transporter transporting the example embodiment portable barrier shown in FIG. 6.

### DESCRIPTION

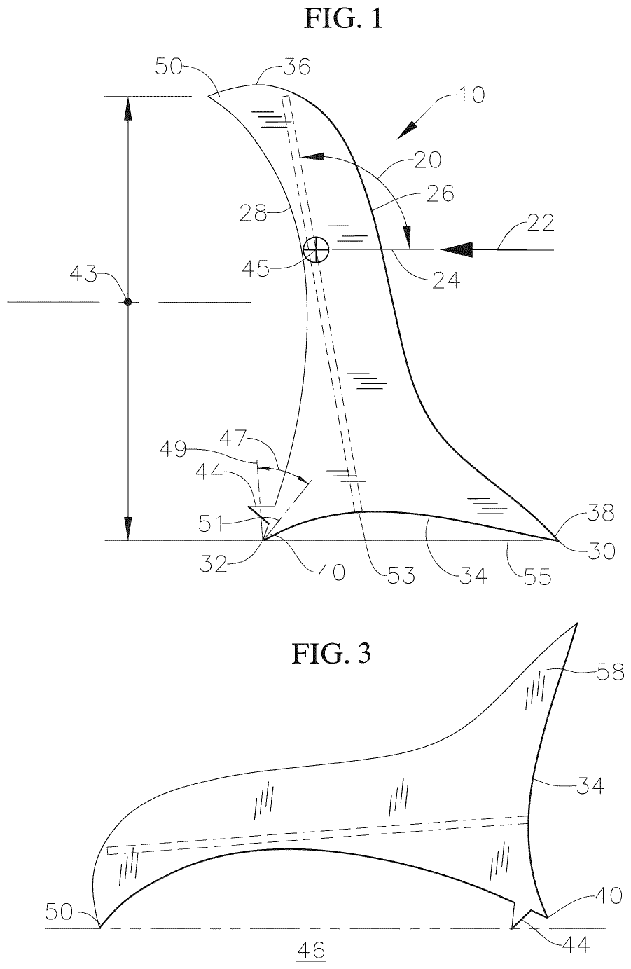

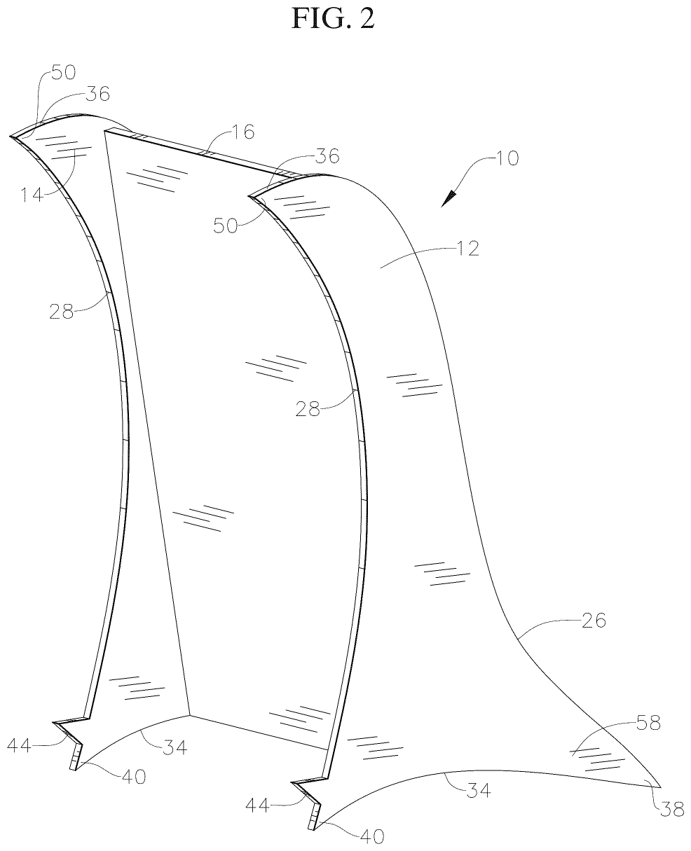

An example embodiment portable barrier 10, as shown in FIGS. 1 and 2, that can be moved into position by one person. The barrier includes two support members 12, 14 and an interconnecting member 16, interconnecting the two support members. In an example embodiment, the interconnecting member is a plate or plate-like member. In one example embodiment, the plate is an upright plate extending vertically or generally vertically. In another example embodiment, the plate extends an inclination angle 20 greater than 90 degrees, from an expected direction of impact 22. For clarity, the angle 20 is measured from a horizontal plane 24 along the expected direction of impact.

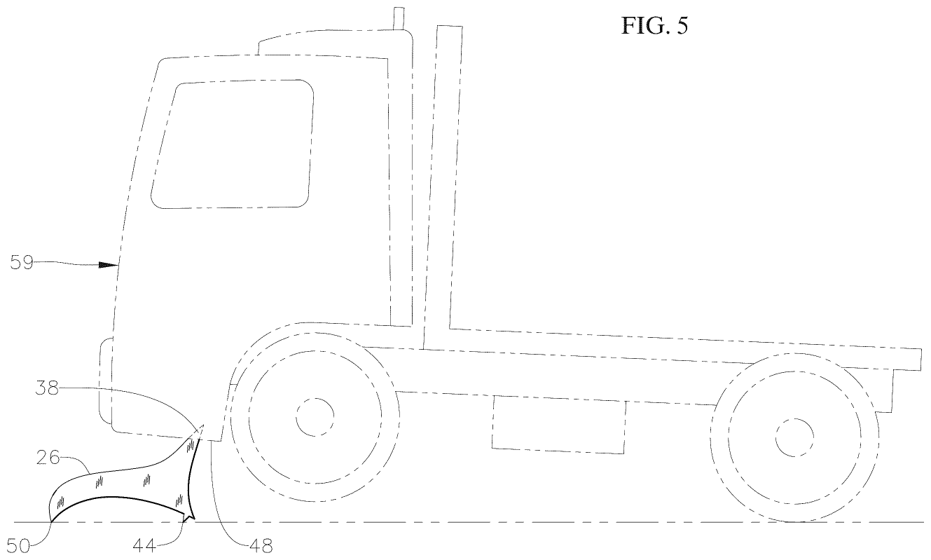

Each support member has a first end 26 for facing the expected direction of impact and a second end 28 opposite the first end. In an example embodiment, each of the support members engages the ground at two locations 30, 32. Each support member has a base end 34 opposite a top end 36. Each support member has, or defines, a first foot 38 for engaging the ground at a first location 30 of the two locations, and a second foot 40 for engaging the ground at a second location 32 of the two locations. In the example embodiment shown in FIGS. 1 and 2, the first foot 38 extends along the first end 26 of each support member. The second foot 40 extends along the second end 28 of each support member. In another example embodiment, the first foot may extend proximate the first end and the second foot may extend proximate the second end. In an example embodiment, the first foot is a first spike and the second foot is a second spike, as for example shown if FIGS. 1 and 2. In another example embodiment, the second foot a rubber foot. A third spike 44 extends from the second end of each support member at a location proximate the second foot 40. In this regard, when a vehicle 59 strikes the barrier 10 from the expected impact direction, the barrier will pivot about the second foot 40 and the third spike of each support member will engage and dig into the ground 46 while the first spike 38 strikes, and often pierces, the undercarriage 48 of the impacting vehicle for aiding in stopping such vehicle, as for example shown in FIGS. 3 and 5. In an example embodiment, the second foot 40 of each support member aids in the pivoting of the barrier, as for example by digging into the ground, or by preventing the rearward movement of the barrier.

In an example embodiment, a fourth spike 50 is defined at the top of each support member along a top end 52, as shown in FIGS. 1, 2 and 3, or extends from the second end proximate the top end (not shown) of each support member. In this regard, when the barrier has pivoted upon impact, as for example shown in FIGS. 3 and 5, the fourth spike 50 also engages the ground 46 and digs into the ground along with the third spike 44 for preventing or limiting the movement of the barrier upon impact, i.e., the movement of the pivoted barrier along the impact direction.

To aid the barrier in pivoting upon impact, the barrier is designed such that its center of gravity 45 is higher, and typically higher than its mid-height 43 and/or rearward and closer to the second foot than the first foot. The mid-height is the middle of the height as measured vertically from the lowest point on the base end to the highest point on the top end of the support members.

In an example embodiment as shown in FIGS. 1, 2, 3, 4 and 5, each support member 12, 14 is a plate (or a plate-like structure). In the shown example embodiment, both support members are identical, i.e., identical plates. The first end 26 of each plate support member extends from the base end 34 of the support member, i.e., plate, and extends toward the top end 36 in a direction that is upward and toward the second end. It then curves further upward. As the first end approaches the top end 36 of the support member it curves toward the second end. In the shown example embodiment, the first end 26 curves into the top end 36 of each support member. In other words, the first end and the top end of each support member together extend along one curving line as for example shown in FIGS. 1, 2, and 3. The second end 28 extends from the top end and gradually curves extending to the base end of the support member defining an arc, i.e., a concave arc or curvature. The intersection of the first end and the top end at the top of each support member (i.e., plate) define the fourth spike 50 pointing in a direction away from the first end 26. In the shown example embodiment, the fourth spike is a V-shaped spike (i.e., a V-shaped projection). The third spike 44 is defined extending from the curved second end 28 of each support member in a location proximate the base end. In the shown example embodiment, the third spike is a V-shaped spike (i.e., projection). In the shown example embodiment, the V-shape spike defines a triangle with its base being tangent to the curve of the second end of its support member such that the V-shaped spike extends slightly upward. In an example embodiment, the third spike is integrally formed on the second end. The base end also forms a gradual arc defining a concave curvature curving from the first end to the second end with the concave arc extending in a direction toward the top end of each support member. The depth of the arc is deepest closer to the second end than the first end. In the shown example embodiment, the depth of the arc is maximum at a location 53 about 35% to 40% of a length of the chord 55 of the arc as measured in a direction from the second end toward the first end. The base end with the second end defines the second spike 40 and the base end with the first end define the first spike 38. The first and second spikes in the shown example embodiment are also V-shaped spikes (i.e., V-shaped projections). The second spike 40 extends along its axis of extension 51 downward and in a direction away from the first end at an angle 47 of about 40 to 50 degrees relative to a vertical 49. In the shown example embodiment, the second spike extends at an angle 47 of about 45 degrees relative to the vertical. The axis of extension 51 of each V-shaped spike which defines a triangle is the axis extending perpendicularly from the triangle base through the apex of the triangle. As can be seen in FIGS. 1, 2, and 3, the base end and the first end define a leg portion 58 extending to the base end and in a direction opposite the second end and beyond the top end. By being V-shaped, the example embodiment spikes are better suited for digging into the ground upon impact of the barrier.

With this example embodiment, the interconnecting member 16 is also a plate, i.e., an interconnecting plate. The interconnecting plate extends from each of the support member plates a location closer to the second end and is inclined relative to the vertical in the inclination angle 20 toward the second end. In the shown example embodiment, the interconnecting plate is inclined at an angle 20 of 100 degrees. In the shown example embodiment, the interconnecting plate extends from the base end to the top end of the support members. In other example embodiments, the interconnecting plate may extend proximate the base end and/or top/end and/or below the base end and/or above the top end of the support members. The location of the interconnecting plate and its angle of inclination, move the center of gravity of the barrier closer to the second end. In addition, the inclination puts a top portion of the interconnecting plate closer to the second end and the lower portion of the interconnecting plate further from the second end. In this regard, the barrier is more inclined to pivot or rotate in a direction toward the second end upon impact.

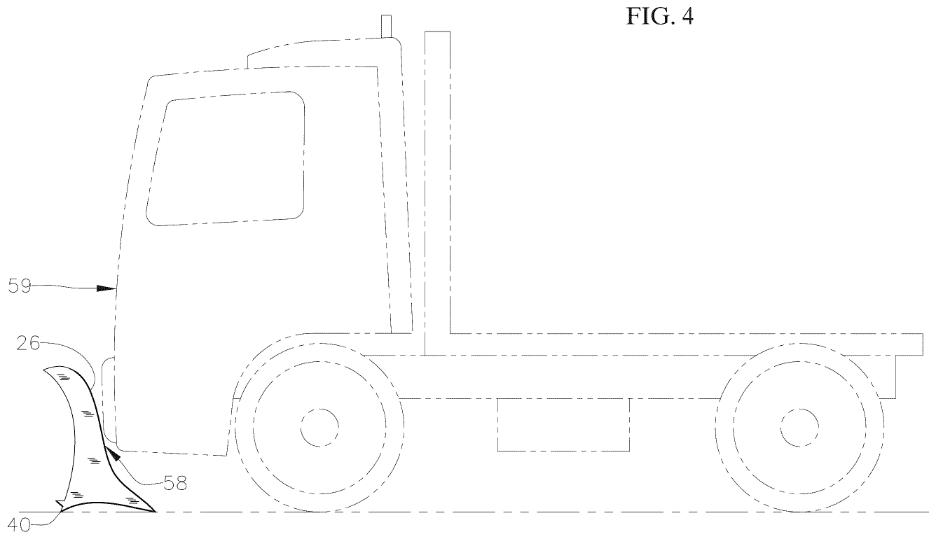

As a vehicle 59 approaches the barrier, it will move over the leg portion 58 of each support member and impact the first ends 26 of the support members as shown in FIG. 4. The impact of the vehicle will cause the second spikes 40 that extend at an angle relative to the vertical to dig into the ground. As vehicle continuous to move in the impact direction it will cause the barrier to pivot about the second spikes 40 and the first spikes 38 will engage the underside of the vehicle. Once pivoted the third and fourth spikes 44, 50 will engage and dig into the ground. The angle of the third spike causes the third spike 44 to dig into the ground as the force of the impact attempts to move the pivoted, i.e., tilted, barrier in the direction of impact. This along with the engagement of the ground by the fourth spike create resistance against the further movement of the pivoted barrier along the direction of impact and as such, the barrier arrests the movement of the vehicle in the impact direction and engages and often impales the undercarriage of the vehicle.

As can be seen, the angle of extension of the third and fourth spikes can be tailored to enhance the digging of these spikes into the ground due to the impact force when the barrier is pivoted. In an example embodiment, the second spike may be covered with rubber to promote the pivoting of the barrier about the second spike upon impact.

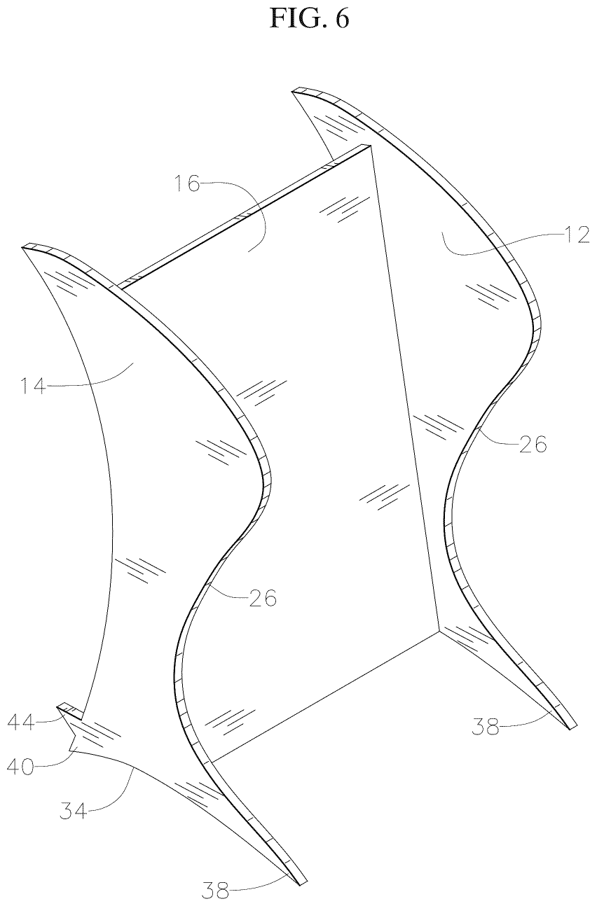

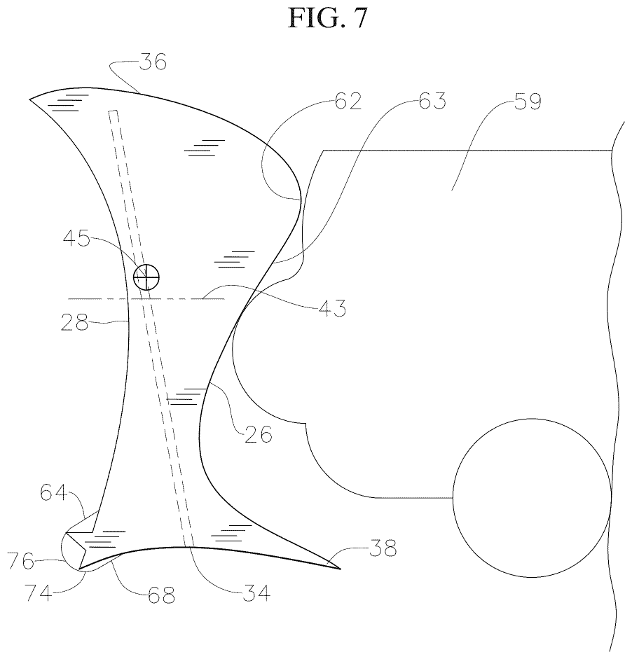

In another example embodiment as shown in FIGS. 6 and 7, the curvature of the first end 26 may be made to be more sinusoidal. For example, the first end curves from the base end in a direction toward the top end 36 such that the curvature extends in a direction toward the second end defining a concave section 60 and then in an opposite direction defining a convex section 62 together defining a sinusoidal wave 63. With this example embodiment, a larger portion (and thus, a larger weight portion) of each barrier support extends above the mid-height 43 of the supports making it easier for the barrier to pivot, i.e., tip over upon impact causing the first spikes 38 to engage the undercarriage of the impacting vehicle 59. Typically, a vehicle bumper will be received in the transition between the concave section 60 and the convex section 62 of the sinusoidal curve and engage the upper part of the support members first ends.

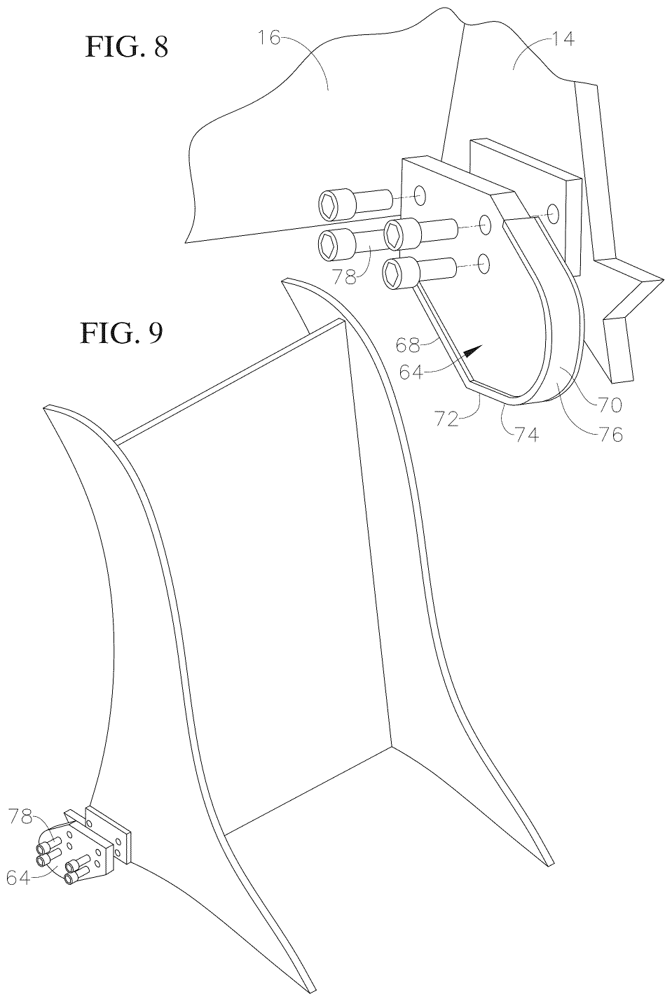

In an example embodiment, when used on a slick surface, a shoe 64 may extend from the inner or outer surfaces of the support member over the second spikes 40 as for example shown in FIG. 7. In an example embodiment, shoes are fastened to the inner or outer surfaces of each support member as for example shown in FIGS. 8 and 9. The third spikes 44 extend beyond the shoes 64 as for example shown in FIG. 7. In an example embodiment, each shoe can be a plate portion having an edge 68 that will contact the ground covered with rubber 70 forming a covered edge 72, as for example shown in FIG. 8. In an example embodiment, the covered edge of each shoe has a flat portion 74 for engaging the ground when the barrier is at an upright position. A rounded portion 76 extends from the flat portion. Once the barrier is being pivoted due to the impact force, the rounded portion will contact the ground and facilitate the further tilting or pivoting. In other words, upon impact the rubber covered flat portion with provide friction again lateral movement of the barrier causing it to pivot. As the barrier begins to pivot, the rounded rubber covered portion engages the ground further facilitating the pivoting. As can be seen in FIG. 8 each shoe may be mounted on an inner surface 76 of each of the support members. It may also be mounted on an outer surface of each of the support members, as for example shown in FIG. 9. Each may be mounted with fasteners 78 or other means.

In an example embodiment, the portable barrier including the support member and interconnecting members are formed from mild steel. In an example embodiment each of the support members and the interconnecting members are plates that are ⅝ inch thick. In other example embodiment, other types of steel and/or thickness of steel may be used which may be selected based on the expected impact forces.

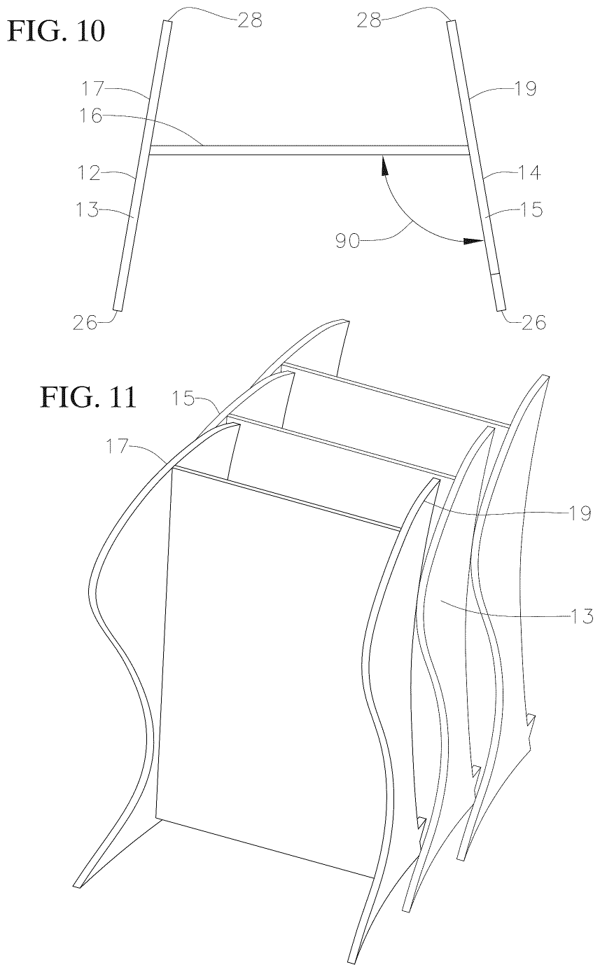

In a further example embodiment, the two support members 12, 14 are inclined relative to the interconnecting member 16 and toward each other as for example shown in FIG. 10. In other words, the support members are not perpendicular to the interconnecting member. In the shown example embodiment, each portion, 13, 15 of each support member 12, 14, respectively, extending to the first end 36 is inclined at an inclination angle 90 relative to the interconnecting member 16, such that said portions 13, 15 are inclined away from each other, increasing their distance, in a direction toward their corresponding first ends 26, as for example shown in FIG. 10. In this regard, second portions 17, 19 of the two support members 12, 14, respectively, are inclined toward each other, reducing their spacing, in a direction toward their corresponding second ends 28. This inclination of the support members allows for the portable barriers to be stacked one in front of the other as for example shown in FIG. 11. The second portions 17, 19 of the supports of a first portable barrier are received within first portions 13, 15 of second portable barrier. In other words. the second portions of the support members of one barrier which reduce in spacing are received within the first portions of another barrier which increase in spacing. The second portions of the support members of the second barrier are received within the first portions of the support members of a third barrier, and so forth.

In an example embodiment, the inclination angle 90 is 100 degrees. Applicants discovered that and inclination angle 90 of 100 degrees allows for easy stacking. In another example embodiment it is the second portions of the side supports that are inclined away from each other in a direction toward their corresponding second ends, such that the first portions of the supports are inclined toward each other in a direction toward their corresponding first ends.

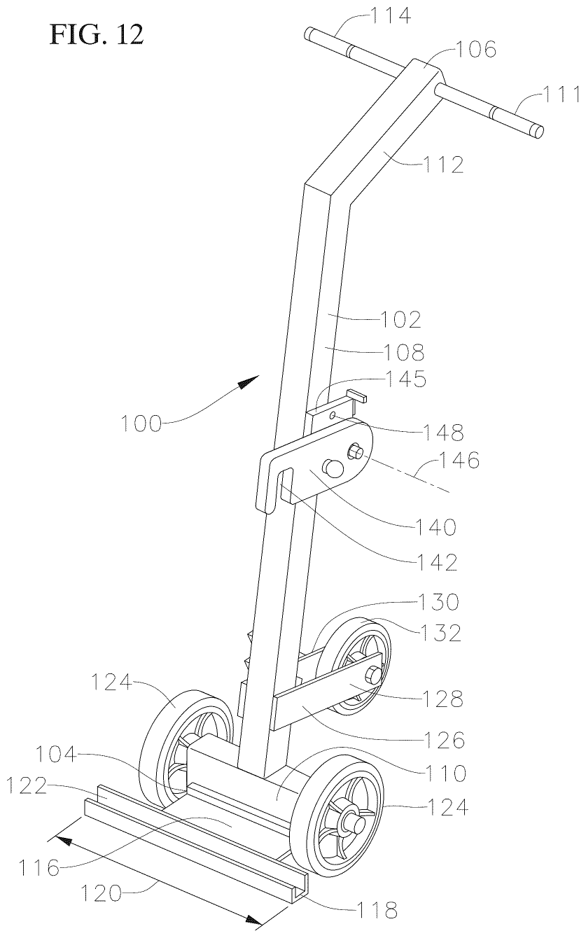

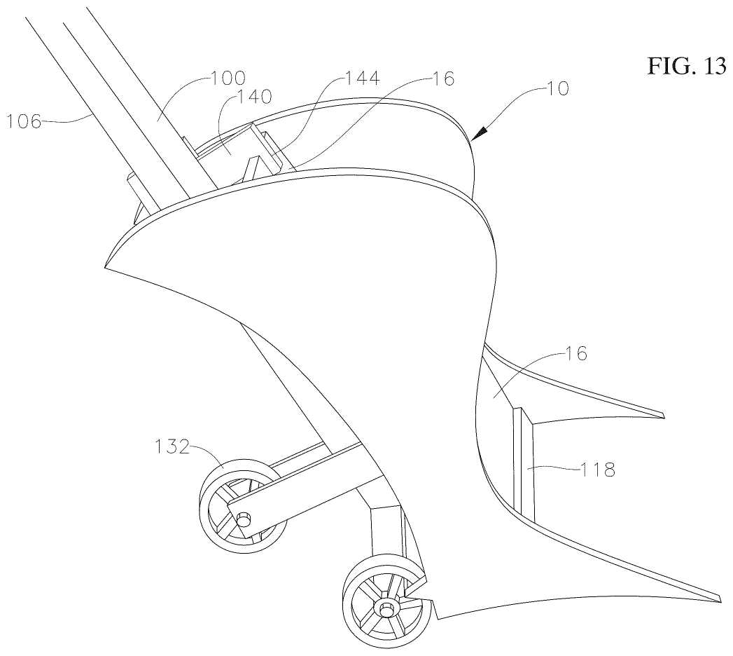

In an example embodiment, a transporter 100, as for example shown in FIG. 12 is used to transport, i.e., move by a single person the example embodiment barriers and to place them in a desired location such as a location that needs to be protected or storage, etc., as for example shown in FIG. 13. An example embodiment transporter, used to transport barriers 10 where the interconnecting member 16 is a plate, has a body 102 having bottom end 104 and a top end 106. In the shown example embodiment, the body has a main portion 108 and a base portion 110. In the shown example embodiment, the main portion 108 is a hollow square beam. The base portion is also a hollow square beam extending transversely from the main portion. In the shown example embodiment, the base portion extends perpendicularly from the main portion. The base portions defines the bottom end 104 of the body. In other example embodiments, the main portion and base portion may be one single uniform member. To provide more leverage when in use, the body may include an upper portion 112 extending at an angle from the main portion 108, as for example shown in FIG. 10. In one example embodiment, the upper portion may also beam a hollow square beam. Two handles 114 may extend from either side of the body upper portion 112. In an example embodiment, the entire body 102 may be integrally formed from one component or multiple components which may be other structures than hollow square beam structures.

A first arm 116 extends transversely from the body at, or proximate, its bottom end 114. In an example embodiment, the first arm extends generally perpendicularly from the body. A channel 118 is defined at, or proximate, a distal end of the first arm 116. In an example embodiment, the channel is a separate member connected (as for example welded or fastened) to the first arm. The channel has a length 120 that extends along a width of the first arm. The length 120 is shorter than the width of the interconnecting member 16 of the barrier 10 that it will transport. In the shown example embodiment, the length 120 of the channel is longer than the width of the first arm. The channel defines a channel depression 122 having a width that is greater than the thickness of the plate defining the interconnecting member 16, so as to be able to receive the interconnecting member. In an example embodiment, the width of the channel depression is between 1 to 5 times the thickness of the interconnecting member 16, so as to account for the fact that the interconnecting member may be inclined.

A first set of two main wheels 124 are coupled to the main body at, or proximate, its bottom end. In the shown example embodiment, the wheels 124 are mounted to the base portion 110 of the body. A second arm 126 extends from the body above the first arm and in a direction opposite the first arm 116. In the shown example embodiment, the second arm is formed by two spaced apart members 128, 130. In an example embodiment, as shown in FIG. 10, the two spaced apart members are plate members. A third wheel 132 is mounted at, or proximate, the distal end of the second arm 126. In the shown example embodiment, the third wheel 132 is mounted between the two members 128, 130 defining the second arm proximate their distal ends. In an example embodiment, the second arm extends along a length, and at a height above the first arm, such that tilting the main body about the first set of wheels to an angle less than 50 degrees causes the second wheel to contact the ground such that the transporter is supported on the ground by the wheels 124 and the third wheel 132, as for example shown in FIG. 13.

The example embodiment transporter as described herein is best used to transport barriers 10 where the interconnecting member 16 does not extend to the ground. To transport a barrier, the transporter is rolled along its first set of main wheels 124 such that the channel depression 122 is aligned with a bottom end of the interconnecting member. The transporter is then tilted backwards about its first set of main wheels 124 such that a bottom end portion of the interconnecting member is received in the channel depression. As the transporter is further tilted, it causes the barrier to lift of the ground and tilt to rest against the body. As the tilting of the transporter continues, the third wheel 132 engages the ground providing further support and preventing the transporter from tilting further. The transporter with the mounted barrier may then be rolled to a desired location with the first set of main wheels 124 and the third wheel 132.

In an example embodiment, to assist with the tilting, supporting and carrying of the barrier, a holding arm 140 is rotatably coupled to the body 102 above the second arm 126. The holding arm has slot 142 extending opening to a lower end of the holding arm, when the holding arm extends in a direction opposite the second arm. When the transporter is moved in position such that upon tilting, the bottom end portion of the interconnecting member 16 of the barrier 10 is received in the channel depression 122, the holding arm is rotated such that an upper end portion 144 of the interconnecting member 16 is received in the slot 142. In this regard the slot must be wide enough to allow the upper end portion of the connecting member to be received therein, and the holding arm must be located at the appropriate height on the body to accommodate the height of the barrier interconnecting member. Once the upper end portion of the interconnecting member is received in the slot, as the transporter is tilted, the holding arm will engage the upper portion 144 of the interconnecting member and assist in the tilting of the barrier against the body. The handle arm also secures the upper end portion of the interconnecting member to the transporter.

In an example embodiment, as shown in FIG. 13, the holding arm is rotatably coupled to a plate 145, mounted on the body 102, about a rotating axis 146. Openings 148 are defined on the plate to receive a spring-loaded plunger 150 mounted on the holding arm. The holding arm may be rotated about the rotating axis 146 such that the plunger is over and aligned with one of the openings 148 when the holding arm is an up position and the slot extends generally horizontally or almost horizontally, i.e., in a disengaged position. When at this position to spring loaded plunger penetrates at least part of the opening 148 for retaining the holding arm at the disengaged position. To rotate the holding arm to a position for receiving the upper portion 144 of the barrier interconnecting member in the slot 142 of the holding arm, the plunger is withdrawn from the opening 148 against its spring force allowing the holding arm to rotate about rotating axis 146. The holding arm is then rotated to an engaged position such that the upper portion of the interconnecting member is received in the slot of the holding arm. When in the engaged position, the plunger is aligned with another opening formed on the plate 145, and the spring force causes the plunger to at least partially penetrate such opening for locking the holding plate in the engaged position.

In other example embodiments, the holding arm 140 may be mounted directed to the body, and instead of a plunger, a pin may be used to lock the holding arm in an engaged and disengaged position. Moreover, in the shown example embodiment the first set of main wheel 124 are spaced apart at a distance less than the width of the interconnecting plate of the barrier to be transported such that the wheels can be located between the support members of the barrier during transporting.

In an example embodiment, the transporter is formed from ASTM A36 hot rolled steel. In the shown example embodiment, the square beam is 3 inch by 3 inch having a thickness of 0.083 inch. In other example embodiments, other types of steel and/or thickness and size of steel may be used that are capable of handling the weight of the portable barriers the transporter is intended to carry.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. Although relative terms such as “outer,” “inner,” “upper,” “lower,” “below,” “above,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially,” “about,” and similar terms are used as terms of approximation and not as terms of degree, and are intended to account for the inherent deviations in measured or calculated values that would be recognized by those of ordinary skill in the art. Furthermore, as used herein, when a component is referred to as being “on” another component, it can be directly on the other component or components may also be present therebetween. Moreover, when a component is component is referred to as being “coupled” to another component, it can be directly attached to the other component or intervening components may be present therebetween.

What is claimed is:

1. A portable barrier transporter comprising:
a body,
a first wheel coupled to the body at, or proximate, a bottom end of the body;
a second wheel coupled to the body at, or proximate, a bottom end of the body, opposite the first wheel, wherein said first and second wheels rotate about a first axis;
a first arm extending transversely from the body at, or proximate the bottom end, of the body;
a channel extending from the first arm parallel, or generally parallel, to first axis for receiving a lower end portion of a plate member of a portable barrier;
a second arm extending from the body in a direction opposite the first arm and above the first arm; and
a third wheel coupled to the second arm, wherein when the body is titled about the first axis, the first, second and third wheels all engage the ground.

2. The transporter of claim 1, further comprising a holding arm rotatably coupled to the body, said holding arm comprising a slot, wherein said slot is for receiving an upper end portion of said plate member of the portable barrier.

3. The transporter of claim 2, wherein the holding arm is rotatable relative to the body from a first position where the slot is in a position for not receiving said upper end portion of the plate and a second position where the slot is positioned to receive said upper end portion of the plate.

4. The transporter of claim 3, wherein said holding arm is lockable at the first position and at the second position.

5. The transporter of claim 4, wherein the holding arm comprises a slideable pin that is received in a first opening when at the first position and in a second opening when in the second position for locking said holding arm in said positions.

6. The transported of claim 5, wherein said pin is a spring-loaded plunger.

7. The transporter of claim 5, wherein a plate is coupled to the body and wherein said first and second openings are formed on said plate.

8. The transporter of claim 5, wherein the body comprises a main portion extending axially and an upper portion extending from an upper end of the main portion at an angle relative to the main portion.

9. The transporter of claim 8, further comprising a first handle extending from the upper portion and a second handle extending from the upper portion opposite the first handle.

10. The transporter of claim 8, further comprising a base portion extending transversely from a bottom end of the main portion.

11. The transporter of claim 10, wherein the base portion extends perpendicularly from the main portion.

12. The transporter of claim 11, wherein the first and second wheels are mounted on the base portion.

13. The transporter of claim 12, wherein the main portion and the base portions are beams.

14. The transporter of claim 13, wherein the main portion and base portion are square beams.

15. The transporter of claim 1, wherein the body is formed from ASTM A36 hot rolled steel.
